(19) United States
(12) Patent Application Publication
(10) Pub. No.: US 2003/0140771 A1
(43) Pub. Date: Jul. 31, 2003

(54) Music spectrum calculating method, device and medium

(76) Inventor: Shigeki Ohshima, Aichi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/257,955

(22) PCT Filed: Apr. 19, 2001
(86) PCT No.: PCT/JP01/03346

(30) Foreign Application Priority Data
Apr. 24, 2000 (JP) 2000-122907

(51) Int. Cl. G10H 1/06; G10H 7/00

(52) U.S. Cl. 84/622

(57) ABSTRACT

When the inner product of signal eigenvalue vectors and azimuth vectors is transformed using an FFT and a MUSIC spectrum is calculated (Step 15), the inner product of noise eigenvalue vectors and azimuth vectors is transformed using the FFT and a MUSIC specturm is calculated (Step 17). A DOA is then estimated based on the MUSIC spectrum obtained (Step 16), thereby decreasing the quantity of calculations required for detecting a DOA of an incident wave using MUSIC algorithm.

### BACKGROUND OF THE INVENTION

1. Technical Field

The present invention relates to MUSIC (Multiple Signal Classification) spectrum calculation using the MUSIC method, which is one method for estimating the direction of arrival (DOA) of incoming waves with a high-resolution. Particularly, the present invention improves efficiency of calculation.

2. Background Art

High-resolution estimation methods have been known as methods for detecting DOA of incoming waves. One of these is the MUSIC method.

The MUSIC method is described, for example, by R. O. Schmidt in “Multiple Emitter Location and Signal Parameter Estimation,” (IEEE Trans., vol.AP-34,No,3,pp.276-280(March 1986)) and by Kikuma in “Adaptive Signal Processing by Array Antennas” (Kagakugijutsu Publication, 1998), and the like. Therefore, specific explanation will not be included herein.

In the MUSIC method, DOA of waves is estimated utilizing using the property that an eigenvalue vector corresponding to a minimum eigenvalue of a correlation matrix of an array antenna input signal is orthogonal to a mode vector which shows DOA of the incident wave. Then, the inner product of the two vectors described is calculated for each DOA, a reciprocal number of the square of an absolute value of the inner product is obtained as a “MUSIC spectrum”, and the DOA of waves is obtained from a peak which appears in the MUSIC spectrum. With this method, it is necessary to repeatedly calculate the inner product so as to derive the MUSIC spectrum, with the result that the number of calculations of the inner product becomes enormous.

Because, as described above, the MUSIC method requires such large calculations, there is a strong demand to reduce this burden. Particularly, in vehicle-mounted radio detection and ranging devices, when a vehicle travelling ahead of the installed vehicle is detected, the situation will change moment by moment and high-speed calculation is necessary. Further, there is a demand that such radio detection and ranging devices be made less expensive and, in order for calculations to be quickly completed by even a relatively inexpensive computer having comparatively low performance, the quantity of the calculations required should be curtailed.

While methods, such as Hirata et al. “High-Speed Calculation Algorithm of MUSIC Azimuth Psophometric Function” (Eleventh Symposium on Digital Signal Processing, Nov. 7-8, 1996) and (A Thesis by Electronic Data Communication Society, B, Vol.J82-B, No.5, pp.1046-1052, 1999/5) and the like, have been proposed for reduction in the quantity of calculations required, these methods only apply to circular equal interval arrays.

### DISCLOSURE OF THE INVENTION

The present invention is a method of estimating, using a MUSIC algorithm, an arrival azimuth of an incoming wave, and is characterized in that the inner product of noise subspace and mode vectors in calculation of a MUSIC spectrum is calculated using Fourier transformation.

By calculating the inner product of mode vectors and noise subspace using Fourier transformation, it is possible to simultaneously calculate all inner products of a prescribed number of azimuths. Because conventionally calculations of an inner product are repeatedly performed as azimuth is varied so as to find the minimum, the present invention greatly is capable of much faster calculation.

The present invention also provides a method of estimating the DOA of incident waves using the MUSIC algorithm characterized in that a calculation of a MUSIC spectrum is performed using signal subspace as a substitute for noise subspace.

When dimension of signal subspace is smaller than the dimension of noise subspace, use of the signal subspace can be more effective in decreasing the quantity of calculations than use of the noise subspace. With the present invention efficient calculation can be carried out in these cases as well.

Further, the MUSIC spectrum may be a function of an azimuth θ, and set such that, if θ is a DOA of an incident wave, the function will be maximal.

Even though signal subspace is used as a substitute for noise subspace, the DOA of an incident wave can easily be detected by finding the maximum of the MUSIC spectrum.

Further, the MUSIC spectrum may be the equation given below, which is preferable for detecting the maximum of P_{MU}.

$${P}_{MU} ( θ ) = \frac{{a}^{H} ( θ ) \cdot a ( θ )}{{Max}_{θ} [ {a}^{H} ( θ ) \cdot {E}_{S} \cdot {E}_{S}^{H} \cdot a ( θ ) ] - {a}^{H} ( θ ) \cdot {E}_{S} \cdot {E}_{S}^{H} \cdot a ( θ ) + ϵ}$$

Here, a(θ) denotes a mode vector whose variable is an azimuth angle θ. Eₛ denotes subspace which is spanned by signal eigenvectors. A function Maxθ [ ], in which the location of θ may be set for convenience of expression, denotes a function which selects a maximum value of a norm of an inner product vector a^{H}(θ)·E_{S}, which is obtained by the Fourier transformation, with respect to θ. ε is a constant parameter for preventing divergence.

Thus, the MUSIC spectrum P_{MU} can be calculated using signal eigenvectors and a DOA can be estimated from the maximum of P_{MU}.

The present invention also provides a method for estimating a DOA of an incident wave by the MUSIC algorithm, and it is characterized in that the number of signal eigenvalues and the number of noise eigenvalues are compared and, when the number of signal eigenvalues is smaller, the MUSIC spectrum is calculated using signal subspace instead of noise subspace. Therefore, a proper judgement can be made as to whether the calculation should be carried out using signal eigenvalue vectors or noise eigenvalue vectors.

Further, the present invention relates to a device for calculating the MUSIC spectrum described above and to a medium in which a program for calculating the MUSIC spectrum is stored. As long as the program can be stored on the medium, it can be any one of a floppy disk, a CDROM, a DVD, a hard disk, or the like, or anything which can provides the program through a means of communication.

### BRIEF DESCRIPTION OF THE DRAWINGS

FIG. 1 is a block diagram showing constitution of a radio detection and ranging device including a signal processing section for carrying out a calculation according to an embodiment of the present invention.

FIG. 2 is a flowchart showing processing in an embodiment of the present invention.

### BEST MODE FOR CARRYING OUT THE INVENTION

An embodiment of the present invention will subsequently be described with reference to the accompanying drawings.

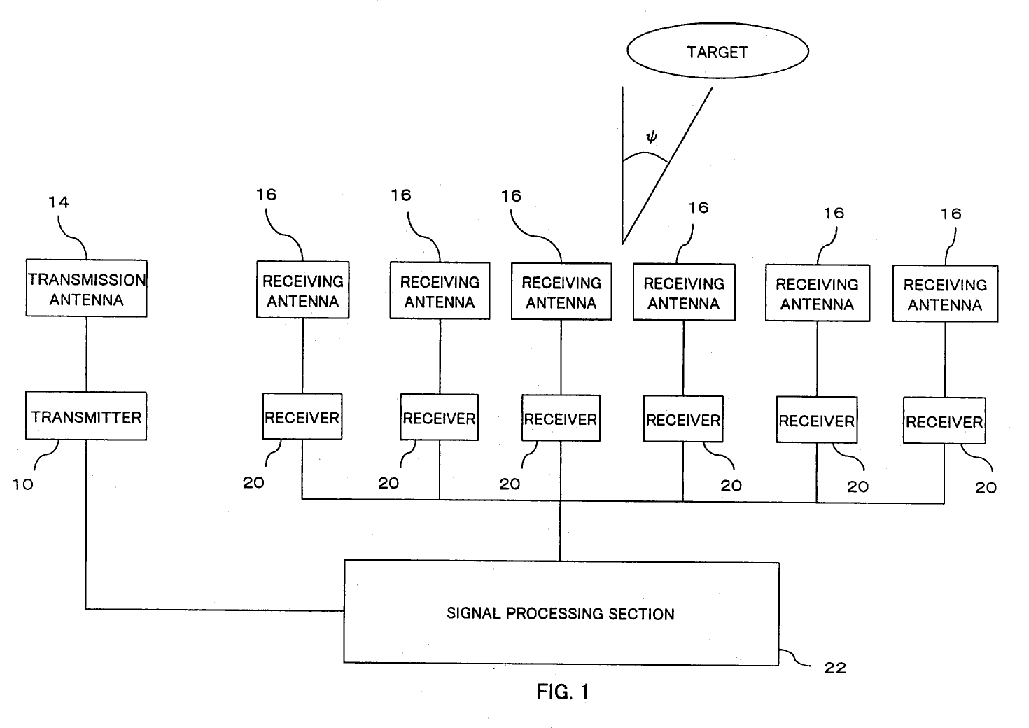

FIG. 1 shows an example of radars utilizing a MUSIC spectrum calculation according to this embodiment, and a transmission antenna 14 is connected to a transmitter 10. Further, six receiving antennas 16 for receiving the reflected wave by targets are installed beside the transmission antenna 14. One receiver 20 is connected to each of the receiving antennas 16. Here, the receiving antennas 16 are equal interval array antennas which are arranged at preset intervals “d”.

A signal processing section 22 is connected to the transmitter 10 and the receivers 20. The signal processing section 22 performs signal processing of every kind for detecting a target including the MUSIC spectrum calculation and detects an azimuth angle ψ of the target.

High resolution DOA estimation to be carried out by the signal processing section 22 using the MUSIC method will next be described.

When the wavelength of the incoming wave is λ, the interval of the equal interval array antennas is d, and the number of the antennas is k (six in the example shown in the drawing), the mode vector a(θ)can be expressed as a function of the azimuth angle θ as shown in equation (1).

$$a ( θ ) = \{ 1 , {ⅇ}^{j \frac{2 π}{λ} d sin θ} , {ⅇ}^{j \frac{2 π}{λ} 2 d sin θ} , ⋯ , {ⅇ}^{j \frac{2 π}{λ} ( K - 1 ) d sin θ} \} \qquad ( 1 )$$

Further, an autocorrelation matrix S of an input signal vector r the element of which is an input signal of each receiving antenna 16 can be defined as shown in equation (2).

S≡\tilde{E}[r·r^{H}] (2)

Here, r^{H} denotes a transposed conjugate of a vector r and E⁻ [ ] denotes time and spatial smoothing. An input signal is composed mostly of a reflected wave (signal) from a target and of noise. By diagonalizing the autocorrelation matrix S, or, in other words, by classifying eigenvalues obtained by expansion according to the rule that eigenvalues corresponding to noise generally have almost the same values and are smaller than signal eigenevalues, the eigenvalues can be classified into eigenvalue vectors based on the input signal and eigenvalue vectors based on the noise.

As a general rule for such a classification, there is one which lists eigenvalues in descending order and classifies them assuming that the eigenvalues based on a noise have almost the same size and are smaller than the signal eigenvalues.

More specifically, when eignevalues r are classified in the following descending order,

γ₁≧γ₂≧γ. . . ≧γ_{L}>γ_{L+1}≈. . . ≈γ_{K} (3)

and when the eigenvalues of r₁˜r_{L} are comparatively large and the eigenvalues of r_{L+1}˜r_{K} are almost same as shown in the above equation, it will be judged such that r₁˜r_{L} are signal eigenvalues and r_{L+1}˜r_{K} are noise eigenvalues.

And, eigenvectors e_{L+1}^{N}, . . . ,e_{K}^{N} (noise eigenvectors) corresponding to eigenvalues based on a noise are orthogonal to eigenvectors e₁^{S}, . . . ,e_{L}^{S} corresponding to eigenvalues based on a signal. Therefore, if θ coincides with a DOA of an incoming wave (for example, ψ shown in the drawing), a mode vector a(θ) will be orthogonal to noise subspace EN={e_{L+1}^{N}, . . . ,e_{K}^{N}} spanned by noise eigenvectors. Thus, the inner product a^{H}(θ)·E_{N} of a mode vector and noise subspace becomes minimal when an azimuth angle θ coincides with a DOA of an incident wave.

A MUSIC spectrum P_{MU}(θ) is a reciprocal number of the square of an absolute value of an inner product and it is defined by the following equation:

$${P}_{MU} ( θ ) = \frac{{a}^{H} ( θ ) \cdot a ( θ )}{{a}^{H} ( θ ) \cdot {E}_{N} \cdot {E}_{N}^{H} \cdot a ( θ )} \qquad ( 4 )$$

In the above equation, when the inner product a^{H}(θ)·E_{N} is minimal, in other words, when θ shows a DOA of an incident wave, the MUSIC spectrum P_{MU} (θ) becomes maximal.

In order to obtain the azimuth angle of an incident wave using the P_{MU}(θ), it is necessary that the equation (4) be repeatedly calculated within a range of azimuth angle of scanning a radar beam so as to detect θ which shows the maximum, which results in an increase of calculation time.

Therefore, in order to achieve a high speed calculation, the inner product a^{H}(θ)·E_{N} is not calculated under the condition that θ is a parameter, but is instead calculated using the Fourier transformation.

More specifically, the inner product a^{H}(θ)·E_{N}

a^{H}(θ)·E_{N}={a^{H}(θ)·e_{L+1}^{N}, . . . , a^{H}(θ)·e_{K}^{N}} (5)

, as shown in the above equation (5), can be written as a vector whose element is an inner product of vectors. Thus, the Fourier transformation is applied to a^{H}(θ)·eᵢ^{N}(i=L+1˜K).

There is a Fast Fourier transformation (FFT) as a method of performing the Fourier transformation at high speed. In order to apply the FFT to this calculation, zero is added to the component of a vector eᵢ^{N} and a vector Xᵢ whose number is M (a power of two) is generated.

Xᵢ={eᵢ₁^{N}, eᵢ₂^{N}, . . . , e_{iK}^{N}, 0, . . . , 0} (6)

This vector Xᵢ is used instead of eᵢ^{N}, and a^{H}(θ)·Xᵢ is transformed using FFT. In this manner it is possible by to obtain a vector inner product value with a pitch of azimuth angle which the inside of a certain azimuthal range Θ is divided into approximately M equal parts by performing only a single transformation. The azimuthal range Θ is equal to an angular range in which ambiguity as to an azimuth angle of an incident wave will not arise in an array antenna, and can be expressed by the following equation.

Θ=2 sin⁻¹(λ/2d) (7)

Further, in order to bring about a pitch of an azimuth angle by division into M equal parts, the following condition must be met:

sin(Θ/2)≈Θ/2 (8)

As described above, in this embodiment, repetitive calculation of the inner product a^{H}(θ)·eᵢ^{N} varying θ in the azimuth vector a(θ) as in the related art is not performed, but rather the inner product of a(θ) and the vector Xᵢ having M pieces of components corresponding to a single noise eigenvector eᵢ^{N} is transformed using the FFT. Thus, it is possible to obtain a vector inner product value with a pitch of azimuth angle which a prescribed azimuthal range is divided into M equal parts by a single calculation. Consequently, a high speed calculation of a MUSIC spectrum from each DOA can easily be achieved and the DOA of an incident wave can be detected from the MUSIC spectrum.

Here, if the number L of incident waves is smaller than the number K of the receiving antennas 16, noise eigenvalues will outnumber signal eigenvalues. On the other hand, because the number of inner product elements in the equation (5) is equal to the number of the noise eigenvalues, the FFT must be calculated corresponding to the number of noise eigenvalues, thereby increasing the number of times the calculation must be performed.

In an example where K is 9 and L is 1, the FFT calculation must be performed eight times in the equation (5). Then, if the number L of incoming waves is small, a calculation of the inner product of a noise eigenvector and a mode vector will, unlike the equation (5), not be performed, but a calculation of the inner product of a signal eigenvector and a mode vector will be performed. This will decrease the number of times the FFT calculation is performed and will enable high speed calculation.

However, in such a case, the MUSIC spectrum in the equation (4) cannot be used, and, therefore, next MUSIC spectrum P_{MU}(θ) in place of the equation (4) is used.

$${P}_{MU} ( θ ) = \frac{{a}^{H} ( θ ) \cdot a ( θ )}{{Max}_{θ} [ {a}^{H} ( θ ) \cdot {E}_{S} \cdot {E}_{S}^{H} \cdot a ( θ ) ] - {a}^{H} ( θ ) \cdot {E}_{S} \cdot {E}_{S}^{H} \cdot a ( θ ) + ϵ} \qquad ( 9 )$$

When E_{S} denotes subspace which is spanned by signal eigenvectors, a function Maxθ [ ], wherein the location of θ may be selected for convenience of expression, denotes a function which selects a maximum value of a norm of an inner product vector a^{H}(θ)·E_{S}, which is obtained by the Fourier transformation, with respect to θ. Further, ε is a constant parameter for preventing divergence.

Similar to equation (6), a prescribed number of zeros are added to eigenvectors such that the FFT calculation can be performed using a vector corresponding to a signal eigenvector eᵢ^{s} in which the number of elements obtained is adjusted. Next, the reason why the MUSIC spectrum will be as shown in the equation (9) when signal eigenvectors are used will be described.

What a mode vector in the same azimuth angle as that of an incident wave is orthogonal to noise subspace is exactly as described above. Thus, a norm of the inner product vector a^{H}(θ)·E_{N} will be minimal when θ is in the same azimuth angle as that of an incident wave, and a denominator in the equation (4) will be minimal. On the other hand, because the mode vector in the same azimuth angle as that of an incident wave is parallel to one of the vectors which span signal subspace, a norm of the inner product vector a^{H}(θ)·E_{S} becomes maximal. Thus, in order for a denominator of the MUSIC spectrum described by equation (9) to be minimal in such a case, it is arranged such that there is a difference between the maximum value of a norm of the inner product vector and a norm of the product vector based on θ. If left unchanged, there may be a case in which the denominator becomes zero. To avoid this, it is arranged such that, by adding a constant parameter, the minimal denominator will not become zero.

As described above, if it is arranged such that the MUSIC spectrum calculation can be performed for both the signal subspace and the noise subspace, the equation (4) and the equation (9) can properly be used according to which of the signal eigenvalues or the noise eigenvalues are greater in number, thereby enabling the reduction of calculation time. In other words, the MUSIC spectrum will be calculated in such a manner that when the number of the signal eigenvalues in the equation (3) is larger, the equation (4) will be used and, when the number of the noise eigenvalues is larger, the equation (9) will be used.

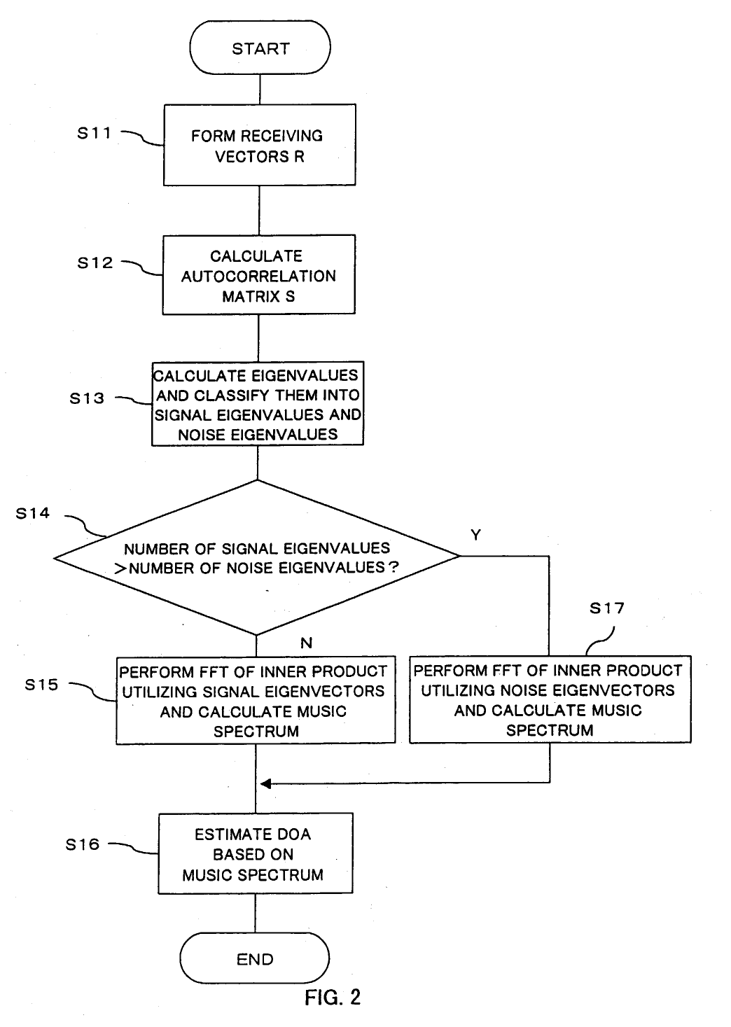

The above processing will be described based on FIG. 2. First, an input signal is taken in and an input signal vector r is formed (Step 11). Next, an autocorrelation matrix S of the input signal vector R obtained is calculated (Step 12). An expansion of eigenvalues is applied to the autocorrelation matrix S, and the obtained eigenvalues γ are listed in descending order and are classified into eigenvalues corresponding to the signal and eigenvalues corresponding to noise (Step 13).

Next, the number of eigenvalues (or eigenvectors) corresponding to the signal is compared with the number of eigenvalues corresponding to the noise (Step 14). When the signal eigenvalues outnumber the noise eigenvalues, the FFT of the inner product of noise eigenvalue vectors (actually, vectors to which a prescribed number of zeros as elements are added) and mode vectors is obtained and the MUSIC spectrum calculated (Step 15).

The DOA is then determined based on the results obtained (Step 16). on the other hand, the noise eigenvalues outnumber the signal eigenvalues, the FFT of the inner product of signal eigenvectors (actually, vectors to which a prescribed number of zeros are added) and mode vectors is obtained and the MUSIC spectrum is calculated (Step 17). The DOA is then determined based on the results (Step 16). It should be noted that, while according to the example shown in FIG. 2 it is arranged such that, when the signal eigenvalues and the noise eigenvalues are equal in number the noise eigenvectors will be utilized, the present invention is not restricted to such a configuration.

As described above, according to the present invention, the inner product of mode vectors and noise subspace is calculated using Fourier transformation, whereby it is possible to perform a collective calculation of the inner product of a prescribed number of azimuths. Thus, high speed calculation can be achieved.

Further, by calculating the MUSIC spectrum using the signal subspace instead of the noise subspace, an efficient calculation can be carried out even when there is a great deal of noise and few signals.

### INDUSTRIAL APPLICABILITY

The present invention can be utilized in radio detection and ranging devices of every kind

1. A MUSIC spectrum calculating method of estimating a direction of arrival (DOA) of an incident wave using a MUSIC algorithm, wherein an inner product of a mode vector and one of noise subspace and signal subspace in a calculation of a MUSIC spectrum is calculated, and when the noise subspace is used, the inner product is calculated using a Fourier transformation.

2. The MUSIC spectrum calculating method according to claim 1, wherein when the signal subspace is used, the inner product is calculated by Fourier transformation.

3. The MUSIC spectrum calculating method according to claim 2, wherein the MUSIC spectrum is a function of a mode θ and is maximal when θ is a DOA of the incident wave.

4. The MUSIC spectrum calculating method according to claim 3, wherein the MUSIC spectrum is the equation
$${P}_{MU} ( θ ) = \frac{{a}^{H} ( θ ) \cdot a ( θ )}{{Max}_{θ} [ {a}^{H} ( θ ) \cdot {E}_{S} \cdot {E}_{S}^{H} \cdot a ( θ ) ] - {a}^{H} ( θ ) \cdot {E}_{S} \cdot {E}_{S}^{H} \cdot a ( θ ) + ϵ}$$
wherein a (θ) denotes a mode vector in which the mode θ is a variable, E_{S} denotes subspace which is spanned by signal eigenvectors, a function Maxθ [ ], for which θ is moved in terms of formulation, denotes a function which selects a maximum value of a norm of an inner product vector a^{H}(θ)·E_{S}, which is obtained with respect to θ by Fourier transformation, and ε is a constant parameter for preventing a divergence, and
a maximum of P_{MU} is detected using this equation.

5. A MUSIC spectrum calculating method according to claim 1, wherein the number of signal eigenvalues and the number of noise eigenvalues are compared and, when the number of signal eigenvalues is determined to be smaller, MUSIC spectrum is calculated using signal subspace and not noise subspace.

6. A MUSIC spectrum calculating device for estimating a DOA of an incident wave using MUSIC algorithm, wherein an inner product of a mode vector and one of noise subspace and signal subspace in a calculation of a MUSIC spectrum is calculated, and when the noise subspace is used, the inner product is calculated using a Fourier transformation.

7. A medium on which a MUSIC spectrum calculation program for estimating a DOA of an incident wave by MUSIC algorithm is recorded, wherein said the MUSIC spectrum calculation program causes a computer to calculate an inner product of a mode vector and one of noise subspace and signal subspace in a calculation of a MUSIC spectrum, and to use a Fourier transformation when the noise subspace is used in a calculation of the inner product.
